(19) United States
(12) Patent Application Publication
(10) Pub. No.: US 2004/0041419 A1
(43) Pub. Date: Mar. 4, 2004

(54) Ball plate handle assembly

(76) Inventors: Brent Nelson Dugan, Hillsborough, NJ (US); John Charles Bonaparte, Parlin, NJ (US); Robert William Gillespie, Brentwood, NH (US)

Correspondence Address: Brent N. DUGAN, 92 WOODS Rd., Hillsborough, NJ, 08844, US

(21) Appl. No.: 10/233,913

(22) Filed: Sep. 3, 2002

(51) Int. Cl. B62J 39/00

(52) U.S. Cl. 294/19.1

(57) ABSTRACT

A ball plate handle assembly has a gripable handle for the operator, a clamping device for attachment/detachment of the invention to a Ball Plate, a brake for the slowing/stopping of the movement of freight, and an adjustable column for operator comfort. The handle assembly provides a measure of safety for the operator by placing him/her a reasonable distance from the freight, reduces damage to the freight by reducing the need to physically contact the freight, reduces possible contamination of the freight by reducing the need to physically contact the freight, reduces the possibility of contaminating the operator by reducing the need to physically contact the freight, and provides for the directional control of the movement of the freight by providing a measure of leverage inherent in the design of the invention.

### BACKGROUND OF THE INVENTION

This invention relates generally to the field of freight movement, and more particularly to an article of manufacture to assist in the movement of freight on a Ball Plate Freight Moving System or a ball plate handle assembly.

With the invention of the wheel Man could move goods, also known as freight, in an easier manner than previously experienced. With the advent of roller conveyor systems, comprised of numerous wheels attached to shafts contained within a ladder type of framework, Man could move freight from point A to point B with less physical exertion and was only restricted by the size, length and strength of the framework. With the invention of the Ball Plate Freight Moving System, comprised of captive ball bearings evenly spaced over a level area with a flat plate resting on and supported by the ball bearings, Man could move freight in any direction he chose. In large areas, such as warehouse facilities, freight could be loaded onto the Ball Plate system at any point and transferred to any other point without the restriction of predetermined paths therefore making the movement and placement of vast amounts of freight easier and more predictable than before.

Freight placed on flat plates on the Ball Plate Freight Moving System is moved from point A to point B by the physical exertion of operators. By making physical contact with the freight and exerting pressure, inertia is induced in the freight to make it travel in the direction of the induced inertia, providing the Ball Plate system is constructed on a flat, level surface. When an incline is introduced into the Ball Plate system gravity will move the freight in the downward direction of the incline. To slow or stop the movement of the freight reverse inertia must be applied directly opposite the path of travel of the freight.

Due to the need of physical contact with the freight to induce inertia for movement, freight such as flowers, vegetables and fruits as examples, may incur damage. Also possible is operator injury due to the operators inability to bring the freight to a stop at predetermined points through misjudgment of the compensating inertia required to stop the travel of the freight. Contamination of freight by operators and contamination of the operators from the freight due to physical contact is also a possibility. Various stacking heights and physical properties of the freight being moved may also require operators to assume unnatural or physically demanding postures to induce inertia to start or stop the movement of the freight. This may lead to over exertion resulting in fatigue, discomfort or physical injury to the operator.

### SUMMARY OF THE INVENTION

The primary object of the invention is to provide a gripable handle for the movement of freight on a Ball Plate freight moving system.

Another object of the invention is to provide a clamping device for the attachment/detachment of the invention to a Ball Plate freight moving system.

Another object of the invention is to provide a brake for the slowing/stopping of freight on a Ball Plate freight moving system.

A further object of the invention is to provide for the directional control of freight on a Ball Plate freight moving system.

Yet another object of the invention is to provide for operator safety by providing a reasonable distance from the freight.

Still yet another object of the invention is to reduce damage to freight on a Ball Plate freight moving system by reducing the need to physically contact the freight.

A further object of the invention is to provide a height adjustment of the invention to accommodate the physical attributes and requirements of the operator.

In accordance with a preferred embodiment of the present invention, a ball plate handle assembly comprises a gripable handle for the operator, a clamping device for attachment/detachment of the invention to a Ball Plate, a brake for the slowing/stopping of the movement of freight, and an adjustable column for operator comfort. Such an assembly provides a measure of safety for the operator by placing him/her a reasonable distance from the freight, reduces damage to the freight by reducing the need to physically contact the freight, reduces possible contamination of the freight by reducing the need to physically contact the freight, reduces the possibility of contaminating the operator by reducing the need to physically contact the freight, and provides for the directional control of the movement of the freight by providing a measure of leverage inherent in the design of the invention.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIGS. 1A and B is a plan view of the ball plate handle assembly in accordance with a preferred embodiment of the present invention showing a side view and a front view.

FIGS. 2A-F is an exploded view of the embodiment of FIG. 1.

FIGS. 3A and B is a plan view of an alternate embodiment of an attachment head unit showing a side view and a front view.

FIGS. 4A and B is a plan view of an additional alternate embodiment of an attachment head unit showing a side view and a front view.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

A ball plate handle assembly comprises a gripable handle for the operator, a clamping device for attachment/detachment to a Ball Plate, a brake for slowing/stopping the movement of the freight, and an adjustable column for operator comfort. The invention provides a measure of safety to the operator by placing him/her a reasonable distance from the freight, reduces damage to the freight by reducing the need to physically contact the freight, reduces the possibility of contaminating the freight by reducing the need to physically contact the freight, and reduces the possibility of contamination of the operator by reducing the need to physically contact the freight and provides for the directional control of the movement of the freight by providing a measure of leverage inherent in the design of the invention.

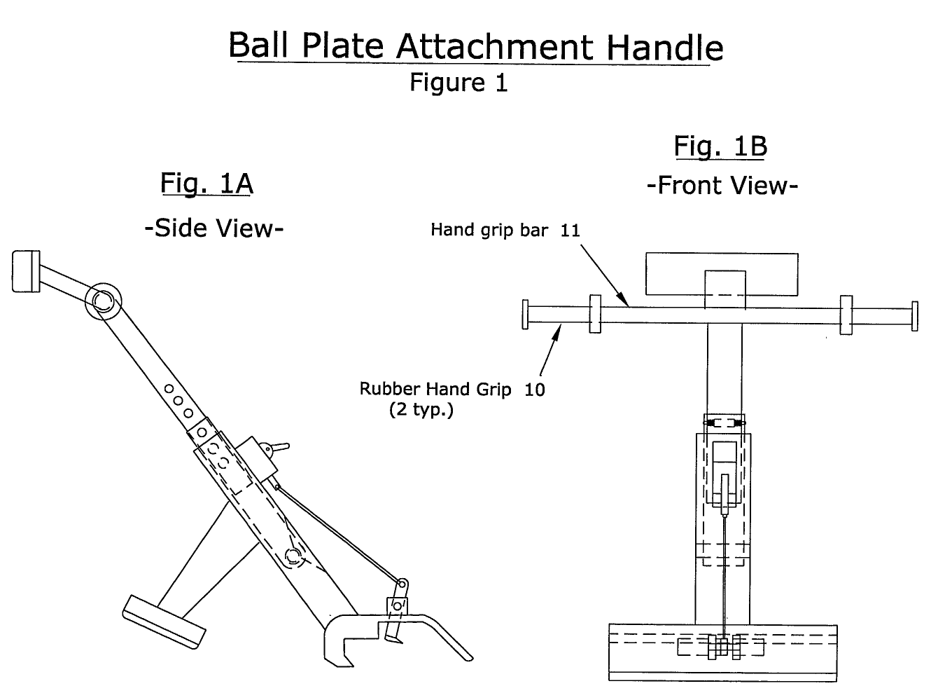

Turning first to FIG. 1, there is shown a side view and front view of the concept of the invention depicting gripable handle 10 for the operator and two rubber hand grips 11 for operator comfort.

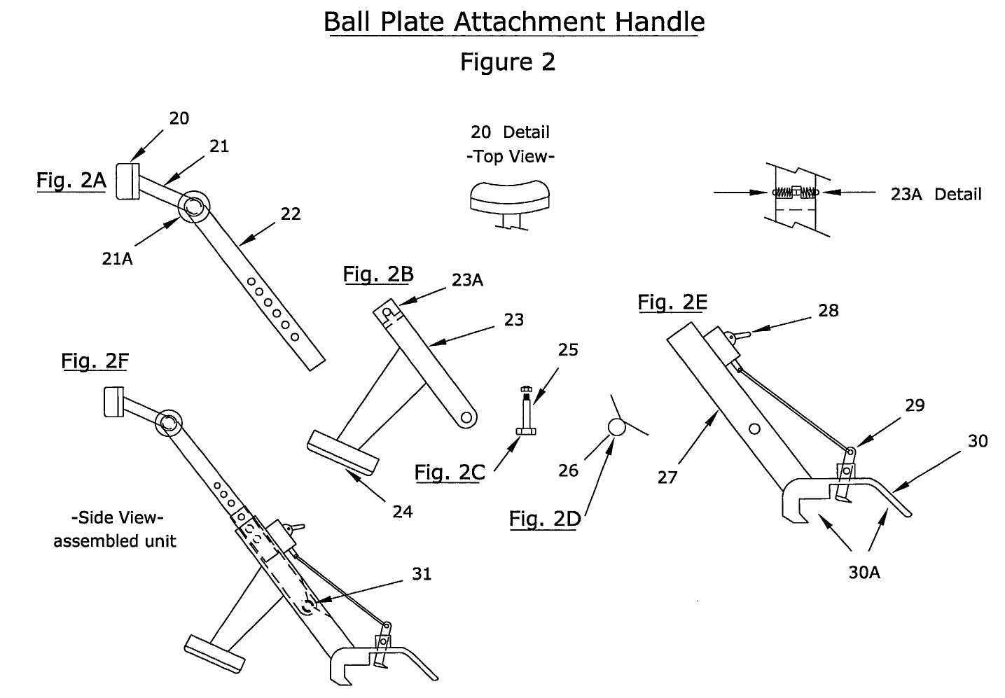

Turning to FIG. 2, there is shown an exploded view of the concept of the invention depicting optional chest pad 20 for operator comfort, a means for mounting the optional chest pad 21, gripable handle 21A for the operator, a means for adjusting the working height of the invention comprising upper component 22 working in conjunction with a securing device 23A mounted within a lower component 23 to provide for the lengthening or shortening of the unit to provide for operator comfort.

Also shown is a brake pad 24 attached to lower component 23 that works in conjunction with a nut and bolt 25 that acts as an axle within a pivot point 31 located in the lower clamping unit 27 that, with downward force applied by the operator on the gripable handle 21A causes the brake pad 24 to contact the Ball Plate Freight Moving System floor inducing friction to the non-ball bearing sections of the floor creating a braking effect to slow and/or stop the movement of the freight.

Also shown is a spring 26 used to assist in the returning of the upper assembled unit to an upright position when the braking action is no longer required. Also shown is an extendable/retractable lever 28 that works in conjunction with a pivoting unit 29 mounted within a unit 30 shaped to the profile of a Ball Plate 30A used on a Ball Plate Freight moving system, that, when working in conjunction with each other act as a clamping mechanism to secure the entire Ball Plate Attachment Handle to a Ball Plate.

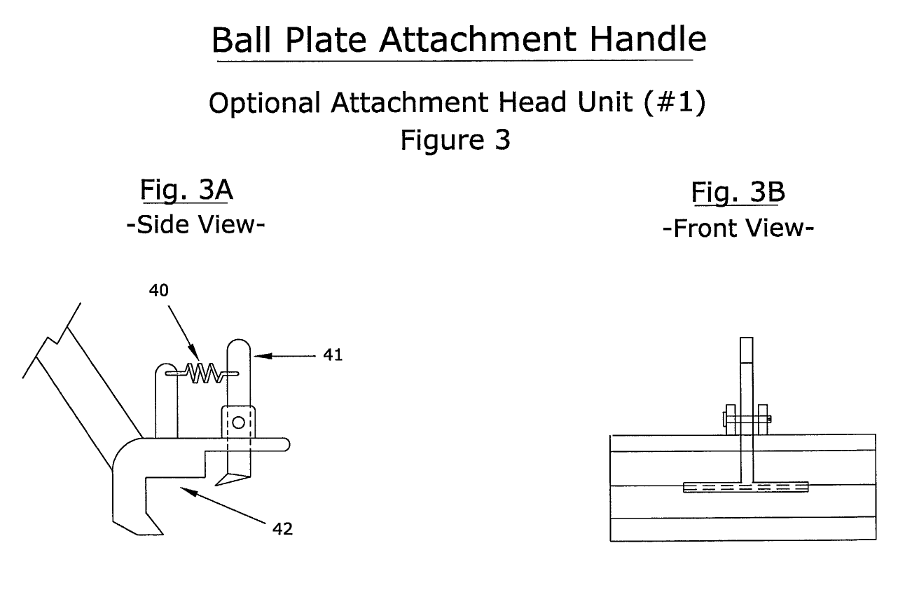

In accordance with the present invention, FIG. 3 shows a side view and a front view of an optional attachment head unit for clamping the Ball Plate Attachment Handle to a Ball Plate used on a Ball Plate Freight Moving System depicting spring 40 working in conjunction with a pivoting device 41 mounted within a unit shaped to the profile of a Ball Plate 42 that forms a clamping mechanism for attaching the Ball Plate Attachment Handle to a Ball Plate used on a Ball Plate Freight Moving System.

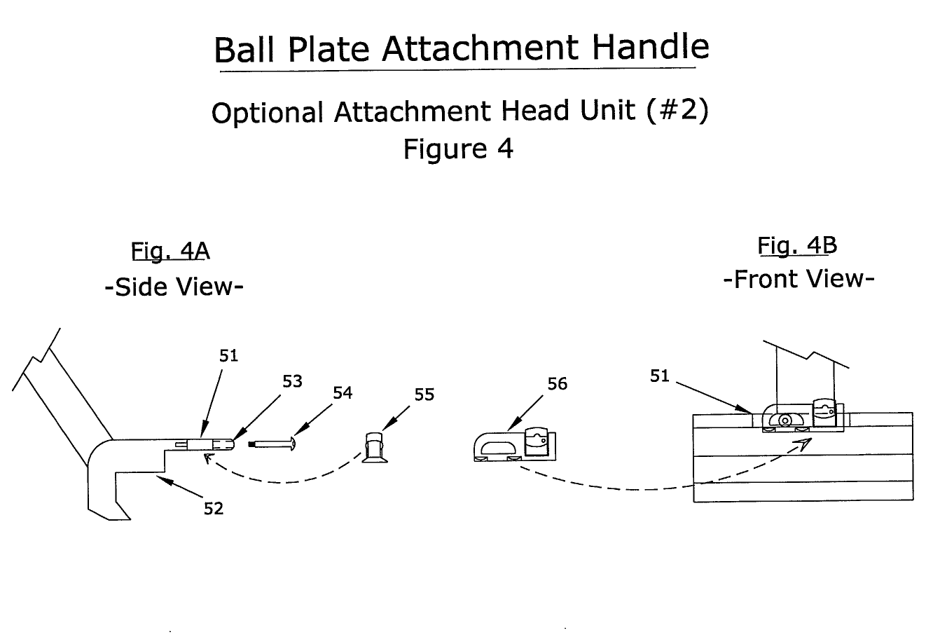

In accordance with the present invention FIG. 4, shows a side view and a front view of an additional optional attachment head unit for clamping the Ball Plate Attachment Handle to a Ball Plate used on a Ball Plate Freight Moving System depicting a slot 51 in a unit shaped to the profile of a Ball Plate 52 used in conjunction with a Ball Plate cargo net securing device of common manufacture, with front view 55 and side view 56, retained in place by a common bolt 54 threaded into a hole 53 that forms a clamping mechanism for attaching the Ball Plate Attachment Handle to a Ball Plate used on a Ball Plate Freight Moving System.

The operation of the invention would require an operator to secure the device to the Ball Plate using the clamping device located at the bottom of the unit. To begin the movement of the freight the operator would be required to push forward on the gripable handle inducing inertia into the Ball Plate to cause motion. Directional control of the movement of the Ball Plate is achieved by using the inherent leverage of the design of the invention to induce lateral motion through compensating lateral inertia. To slow, or bring the movement of the Ball Plate to a stop, the operator could either press downward on the gripable handle causing the brake to come in contact with the non-ball bearing surface of the Ball Plate floor inducing friction or the operator could place reverse inertia on the movement of the Ball Plate by leaning backwards slightly while gripping the gripable handle. The design of the invention would allow for additional units of the same manufacture to be attached to a Ball Plate thereby decreasing the amount of physical effort required by one operator while working in conjunction with other operators performing the same duty. Additional units attached to the Ball Plate, manned by additional operators, could also make the directional control of the Ball Plate easier through coordinated and combined lateral inertia applied to the movement of the Ball Plate.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A ball plate handle assembly comprising:
a gripable handle for the operator;
a clamping device for attachment/detachment of the invention to a Ball Plate;
a brake for the slowing/stopping of the movement of freight; and
an adjustable column for operator comfort.
